(19) United States
(12) Patent Application Publication
(10) Pub. No.: US 2026/0111967 A1
(43) Pub. Date: Apr. 23, 2026

(54) DEMOGRAPHIC INFORMATION CHANGE MANAGEMENT AND RECOMMENDATION SYSTEM, AND APPLICATIONS THEREOF

(71) Applicant: VEDA DATA SOLUTIONS, INC., Madison, WI (US)

(72) Inventors: Robert Raymond LINDNER, Madison, WI (US); Dylan GAFFNEY, Cincinnati, OH (US)

(73) Assignee: VEDA DATA SOLUTIONS, INC., Madison, WI (US)

(21) Appl. No.: 18/919,169

(22) Filed: Oct. 17, 2024

(51) Int. Cl. G06Q 40/08; G06F 16/23

(52) U.S. Cl. CPC G06Q 40/08; G06F 16/2358; G06F 16/2365

(57) ABSTRACT

Disclosed herein are system, method, and computer program product aspects for managing and recommending changes of demographic information. An example implementation may operate by receiving a data file containing a plurality of changes associated with one or more fields of one or more entries of demographic information. The implementation may then aggregate the data file based on identifying the plurality of changes in the one or more fields of demographic information to generate an aggregated data file. The implementation may then generate a user interface to request a user to provide a user preference. The implementation may then compare a level of aggressiveness provided by the user to respective scores associated with one or more changes within the one or more entries of the aggregated data file to identify a subset of the one or more changes to apply. The implementation may then apply the subset of the one or more changes to the data file to generate an updated data file. The implementation may then export, in the user interface, the updated data file to the user. The implementation may then update a plurality of scores associated with a plurality of updated changes to be applied in the updated data file.

### BACKGROUND

As technology advances, an ever-increasing amount of demographic information is becoming digitized. Healthcare providers regularly send medical rosters to health insurance companies and share demographic information to other healthcare providers and physicians. Inaccurate or unreliable demographic information can lead to misguided decisions that could potentially affect the business of health insurance providers, physicians, and healthcare providers.

Systems may exist that assist in detecting potentially erroneous information and suggesting possible changes. However, a health insurance company or other organizations may not want to apply all the suggested changes as maintaining high data accuracy may sacrifice data adequacy or completeness or incur high administrative cost. Systems and methods are needed to assist in selectively adopting possible changes while ensuring that data is reliable and applicable for decision-making.

### BRIEF DESCRIPTION OF THE FIGURES

The accompanying drawings are incorporated herein and form a part of the specification.

FIG. 1 is a block diagram of a change management and recommendation system, according to aspects of the present disclosure.

FIG. 2 is a flowchart illustrating a method for managing and recommending changes of demographic information, according to aspects of the present disclosure.

FIG. 3A is an example illustrating different actions for managing changes of demographic information, according to aspects of the present disclosure.

FIG. 3B is an example illustrating different actions for managing changes of demographic information, according to aspects of the present disclosure.

FIG. 3C is an example illustrating different actions for managing changes of demographic information, according to aspects of the present disclosure.

FIG. 3D is an example illustrating different actions for managing changes of demographic information, according to aspects of the present disclosure.

FIG. 4 illustrates an example computer system useful for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for managing and recommending changes of demographic information. This disclosure is directed to a user-centric demographic information change management and recommendation system to create interactive, efficient, effective, and adaptive changes to enhance the data quality of demographic information.

Traditional systems for demographic information change management may suffer from technological problems and challenges associated with managing and updating the changes. Health insurance companies may need to have correct and current demographic information about healthcare providers to correctly reimburse them for claimed services, or alternatively, to detect fraudulent insurance claims. Often times the information that is shared between the healthcare providers and the health insurance companies is inaccurate. Traditional systems identify and fix this incorrect or inaccurate demographic information based primarily on analyzing the data attributes, characteristics, or other contexts in the data file. However, some of these approaches to identify and fix the data may themselves struggle with data accuracy.

Implementations described herein solve technological challenges associated with managing and updating the demographic information changes by generating a user interface that allows health insurance companies (e.g., the user) to provide their preferences in managing and updating the changes of demographic information. For example, the user may provide a user preference in the user interface to indicate one or more fields of demographic information in a data file that the user wants to apply the change and a level of aggressiveness to apply the change. Within the user interface, the provided user preference may improve the traditional systems by generating a personalized change of the demographic information to match any needs of the user. Compared to using data analysis approaches to decide whether the changes need to be applied regarding a specific user, the user interface may increase the data accuracy by requesting a user preference that facilitates such decision makings. Also, the user preference provided in the user interface may increase the system processing speed, since, as instructed by the user preference, not all changes associated with the fields or entries need to be considered. As such, only a portion of the changes may be applied and this adaptive processing may increase the system efficiency in handling a large scale of demographic information changes from various sources of data. In addition, the user interface may support real-time input of the user preferences to dynamically modify, update, and/or apply the changes.

Furthermore, traditional demographic information change management systems may suffer from technological problems and challenges associated with recommending the changes to appropriate users if the systems want to get any feedbacks or preferences from the user with similar interests regarding those changes. For example, health insurance companies located at a region (e.g., a geographical location) may be more interested in enhancing the data quality of demographic information within a radius of that region. Traditional systems have several limitation in recommending these demographic information changes. For example, traditional systems often do not consider the cross-correlation between data, which can lead to less accurate recommendations. In addition, traditional systems struggle with a problem of data sparsity in that there are plenty of items but few user interactions are associated with each item. For example, if a user wants to see which user bought which item or which user rated which item, traditional systems may have problems obtaining this data since in practical scenarios users may not rate or buy every item — that is, a large number of users may be concentrated on a few items and hence a certain amount of items may be untouched by users. Since the users do not have any action of other uses on some items while the users have it on a certain small number of items, this emptiness of interaction may result in a data sparsity problem.

Implementations described herein solve these technological challenges associated with recommending the demographic information changes based on using an AI-based recommendation engine. The AI-based recommendation engine may perform cross-fields, cross-entries, cross-tabulation, cross-sectional, and/or any other cross-domains analysis to analyze and interpret the data. The AI-based recommendation engine may analyze cross-time-series data files to capture any temporal correlation between different times of the data files. The AI-based recommendation engine may also analyze the recommendations at different time stamps to extract any trends, patterns, and/or correlations from historical recommendations that can improve the system recommendation. In addition, the AI-based recommendation engine may be used in conjunction with the user interface and/or collaborative filtering to provide diverse user preferences that can address the data sparsity problem by associating the recommendation with related user preferences — not only from users themselves. In particular, the AI-based recommendation engine may identify users with similar behavior to the target user. The AI-based recommendation engine may also identify similarities between recommended items themselves — it may identify the history of user interactions and may recommend items similar to the ones the user has previously interacted with.

In summary, implementations described herein represent a user-centric demographic information change management and recommendation system utilizing at least one of a comprehensive user interface, an AI-enable recommendation module, and/or a dynamic change management and update module. Different modules and user interface may collaborate to autonomously manage various aspects of demographic information changes and intelligently recommend potential demographic information changes to the user. Based on the user preferences, this system may apply an optimized set of demographic information changes to the data file to improve the data quality, including but not limited to, accuracy, completeness, consistency, timelines, and/or uniqueness of the data file. This system may also prioritize demographic information changes to make based on minimizing a cost to carry out those changes. These and other aspects of the present disclosure will be described in further detail below with respect to the accompanying drawings.

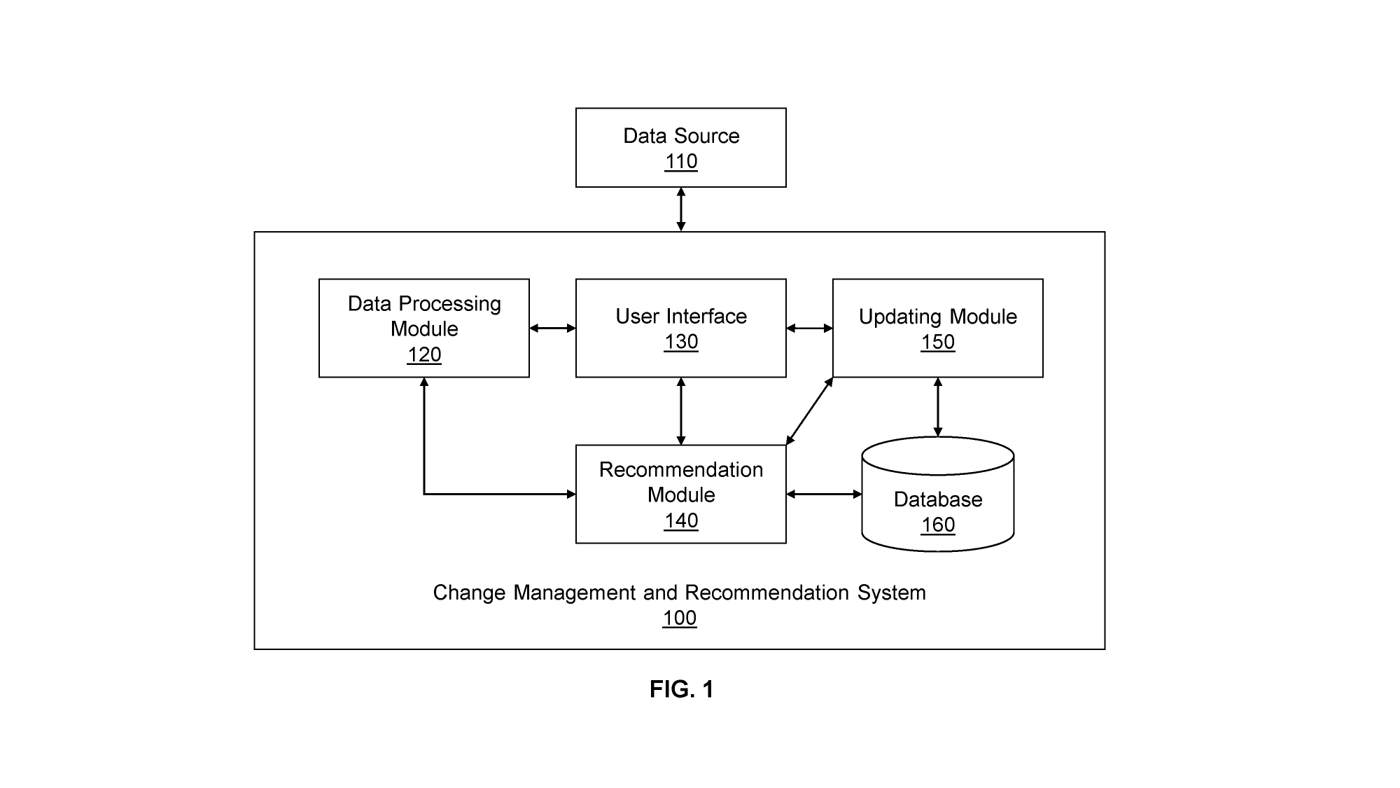

FIG. 1 is a block diagram of change management and recommendation system 100, according to aspects of the present disclosure. In some aspects, change management and recommendation system 100 may include, but is not limited to, a data processing module 120, a user interface 130, a recommendation module 140, an updating module 150, and/or a database 160. Data processing module 120 may include one or more processors, buffers, servers, routers, modems, antennae, and/or circuitry configured to interface with user interface 130 and/or recommendation module 140. User interface 130 may include one or more processors, buffers, servers, routers, modems, antennae, and/or circuitry configured to interface with data processing module 120, recommendation module 140, and/or updating module 150. Recommendation module 140 may include one or more processors, buffers, servers, routers, modems, antennae, and/or circuitry configured to interface with data processing module 120, user interface 130, updating module 150, and/or database 160. Updating module 150 may include one or more processors, buffers, servers, routers, modems, antennae, and/or circuitry configured to interface with user interface 130, recommendation module 140, and/or database 160.

In some aspects, data source 110 may be a separate computing platform including but not limited to smartphones, tablet computers, laptop computers, desktop computers, web browsers, and/or other computing devices, apparatuses, systems, or platforms. In some aspects, data source 110 may transmit information to change management and recommendation system 100 either in a wired or wireless manner and may be, for example, the Internet, a Local Area Network, or a Wide Area Network. The transmission may utilize a network protocol, such as, for example, a hypertext transfer protocol (HTTP), a TCP/IP protocol, Ethernet, or an asynchronous transfer mode.

In some aspects, change management and recommendation system 100 may receive data from data source 110. The data from data source 110 may include a data file, user preference data, and/or other user input data.

In some aspects, the data file may refer to any data files obtained from a change generation engine or system. The data files may contain changes associated with one or more fields of one or more entries of demographic information. In some aspects, an entry may refer to a single row of data, essentially a complete set of information about a specific entity (e.g., a healthcare provider such as a physician), while a field may be a single piece of information within that entry, representing a specific attribute or characteristic of the entity (e.g., an address or portion of an address). Each column in the data file may be considered as a field, and each row may be considered as an entry. For example, for healthcare providers, the demographic information may include, but is not limited to, their name, address, specialties, academic credentials, certifications, and the like. This demographic information may be available from private data sources, such as medical rosters maintained by healthcare providers, and various public data sources, such as medical rosters or websites.

In some aspects, a change in the data file may include an associated score indicating a confidence level of applying the change. Typically, a confidence level is a statistical measure of the percentage of test results that can be expected to be within a specified range. In some aspects, statistical techniques may generate a confidence level by calculating a confidence interval around a sample statistic, which may be achieved by using methods, including but not limited to, a t-test or a z-score. These statistical techniques may take into account the sample size, standard deviation, and desired confidence level to determine a range within which the true population parameter is likely to fall with a specified probability. In some aspects, a confidence level may be used to describe how sure that the changes in the data file are accurate.

In some aspects, the user preference data may refer to any information or message conveyed in phrases that a user would use to describe a tolerance that the user may have to changes in the data, including but not limited to in the multimodal form of text, speech, and/or voice. Also, the user preference data may also include, but is not limited to, commands to more complex sentences, paragraphs, and/or questions to indicate the one or more fields of demographic information in the data file that the user wants to apply the change.

In some aspects, other user input data may refer to any user related data, profiles, and/or attributes that may keep the user input or information up-to-date and ensure that interactions and recommendations between the user and change management and recommendation system 100 are accurate. For example, the other user input data may be categorized into explicit data information that a user may provide intentionally, such as ratings, likes, reviews, and comments, and implicit data information that may not be provided intentionally by the user but may be gathered from available data streams related to the user, such as search history, clicks, and order history.

Referring back to FIG. 1, after change management and recommendation system 100 receives the data from data source 110, data processing module 120 may be triggered by the data characteristics that matches predefined criteria in data processing module 120. These criteria may be determined based on a list of factors including but not limited to types of data input, the system capabilities, the computational resource, and/or any transmission effects. Data processing module 120 may then process the data from data source 110 based on the criteria. The data processing may include, but is not limited to, data preprocessing, data converting (e.g., from user speech data to text data), data embedding, and/or data aggregating. For example, data processing module 120 may perform data aggregating to the data file. Data aggregation is the process where data is collected and presented in a summarized format for statistical analysis and to effectively achieve business objectives. Within data processing module 120, the data aggregating may remove one or more redundant entries of the data file that do not have any associated changes. In some aspects, the data aggregating may be performed by user preference in which one or more entries at a user preferred field may be manipulated to generate related clusters of data within that field. For example, the data aggregating may group the entries at a field with a same healthcare provider. By selecting relevant attributes or fields of the data file and applying aggregation functions, data processing module 120 may create an aggregated data file that can be queried faster than raw data file.

In some aspects, data processing module 120 may also categorize a score associated to a change to an action level. In some aspects, the change of the data file may include, but is not limited to, removing the one or more fields of the one or more entries, and/or adding one or more additional fields to the one or more entries. In some aspects, the change may also include data editing and/or data modifying the one or more fields of the one or more entries. In some aspects, the data editing may include, but is not limited to, micro-editing, macro-editing, and/or selective editing. It can also involve using tools like graphical editing or interactive editing. In some aspects, the data modification may include, but is not limited to, validating data, deleting erroneous entries, and/or updating values.

In some aspects, the categorization may divide the range of a score into bins of intervals and assigning the score to a respective bin (e.g., action category). The action category may include, but is not limited to, an aggressive, a moderate, and/or a conservative category. In some aspects, data processing module 120 may additionally perform comparison between the user input and the action category. By doing this, data processing module 120 may use natural language processing (NLP) and/or machine learning techniques to analyze and understand the meaning of different texts or other multimodal user inputs describing the user preference and the action category.

After the data from data source 110 is processed at data processing module 120, data processing module 120 may transmit the processed data to a user interface 130. The processed data may include, but is not limited to, an aggregated data file and/or any other processed formats of the data file. User interface 130, with an interactive design, may send request to the user at data source 110 to provide any user preference. The user preference may include, but is not limited to, indicating a field of demographic information in the aggregated data file that the user may want to apply the change to and/or a level of aggressiveness that the user may want to apply the change. In some aspects, user interface 130 may support multimodal user inputs including but not limited to text, speech, image, and/or video. The multimodal user inputs from data source 110 may be processed at data processing module 120 to convert them to match specific formatting or type options of the field in the aggregated data file. In some aspects, user interface 130 may send a request to the user at data source 110 to provide a level of aggressiveness that the user may want to apply the changes to the aggregated data file in which the level of aggressiveness may include, but is not limited to, an aggressive, a moderate, and/or a conservative category.

Data processing module 120 may also, after processing the data, transmit the processed data and any other user input data to a recommendation module 140. Recommendation module 140 may analyze the aggregated or raw data file (e.g., if no processing has been performed in data processing module 120) to provide any recommendations or suggested changes or actions to the user. Recommendation module 140 may use machine learning models to analyze the data file and generate personalized recommendations to the user. As a context, recommendation module 140 may rely on other user input data about user interactions in user interface 130 or retrieved from database 160, such as past purchases, search queries, ratings, demographic information, impressions, clicks, and likes, to learn their preferences and predict what a user might want in the data file. In some aspects, recommendation module 140 may use one or more machine learning models including but not limited to collaborative filtering, content-based filtering, and/or hybrid approaches to generate such recommendations. Recommendation module 140 can then suggest changes or actions that may be applied to the data file to the user via user interface 130. User interface 130 may then send a request to the user at data source 110 to provide any user input to identify whether the user wants to apply the one or more change or action recommendations. In some aspects, recommendation module 140 may directly transmit the suggested changes or actions to updating module 150 if those changes or actions may have been approved by the user.

After receiving the user input from data source 110 that identifies the user preference to apply those changes, user interface 130 may transmit the one or more changes that the user wants to apply to an updating module 150. Updating module 150 may store the changes into a database 160. Updating module 150 may further send, in user interface 130, a request back to the user to request an additional user input to identify which parts of the changes that may be applied during a period of time. Updating module 150 may then apply those changes identified by the additional user input to generate an updated data file. Updating module 150 may then export the updated data file back to the user. In some aspects, updating module 150 may transmit the updated data to user interface 130 for preview or review before it can be exported to the user. In addition, in some aspects, updating module 150, based on the additional user input, may dynamically update the changes in database 160 by removing the changes that have been applied and/or also adding additional changes to be applied. The additional changes may be determined from the user inputs in user interface 130 and/or recommended by recommendation module 140.

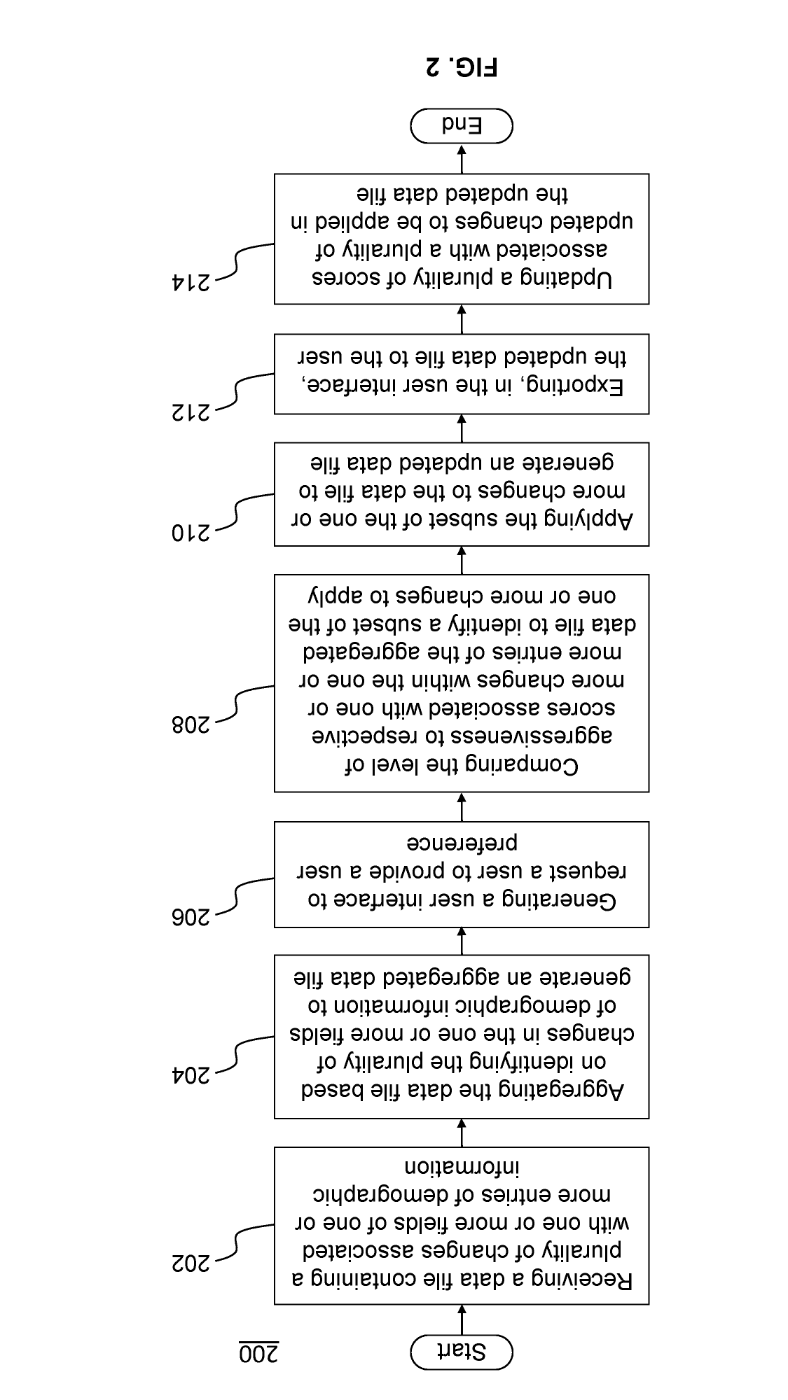

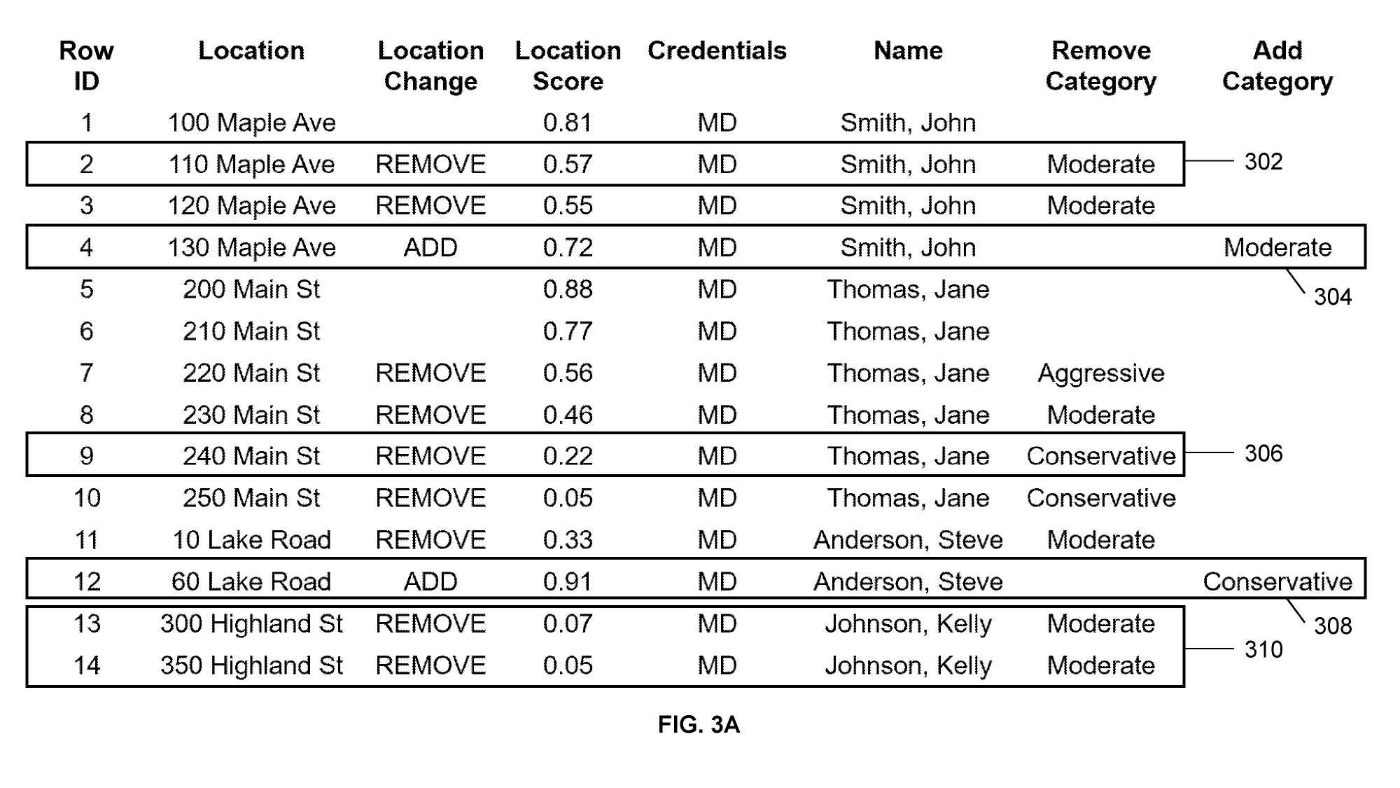

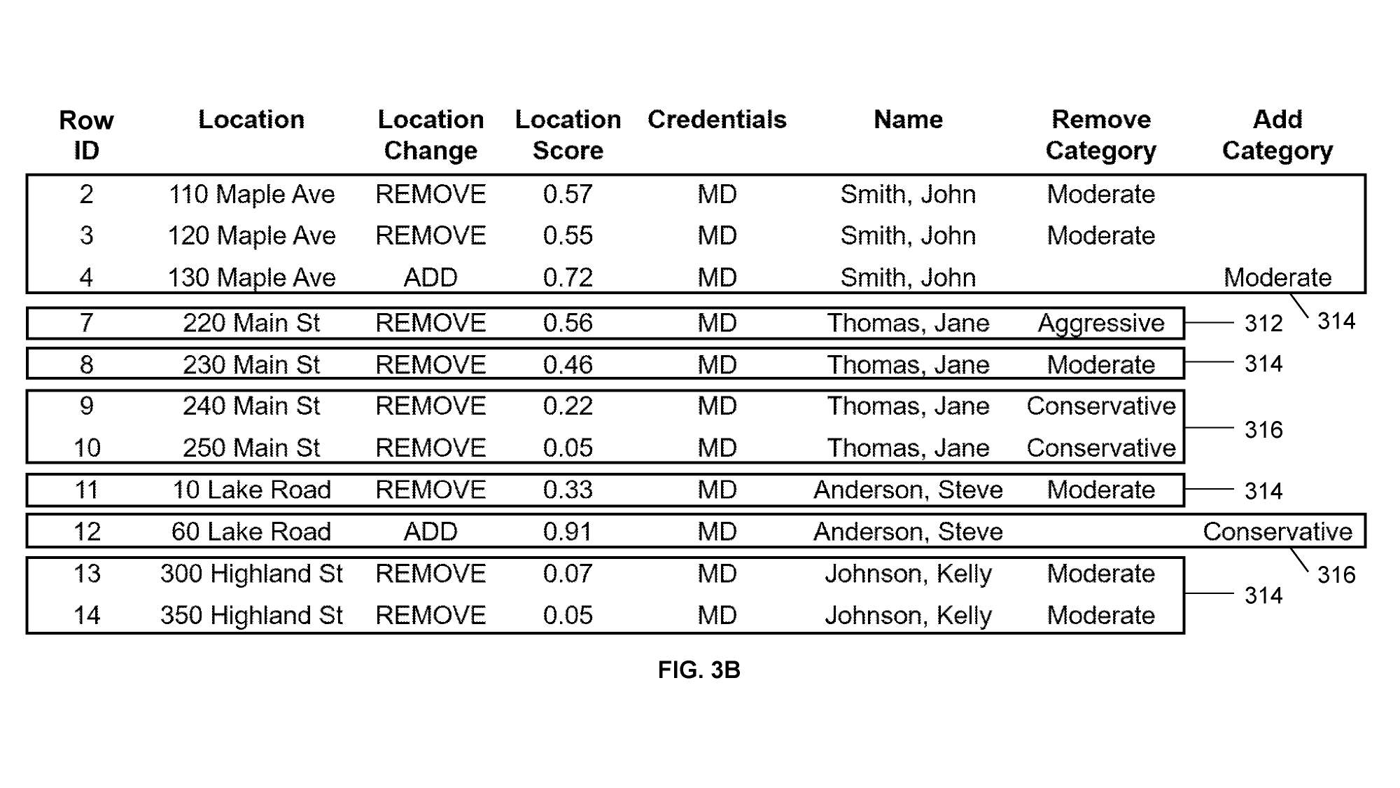

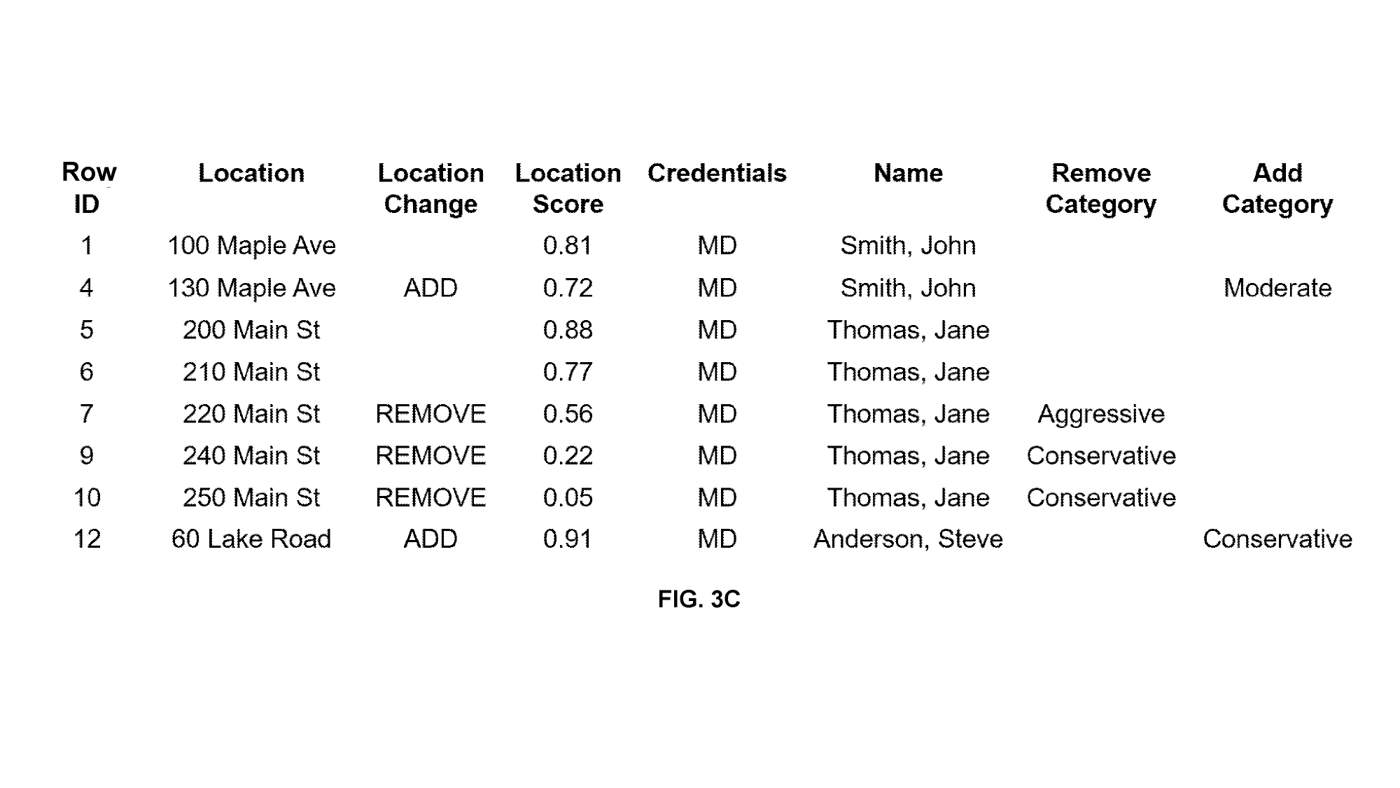

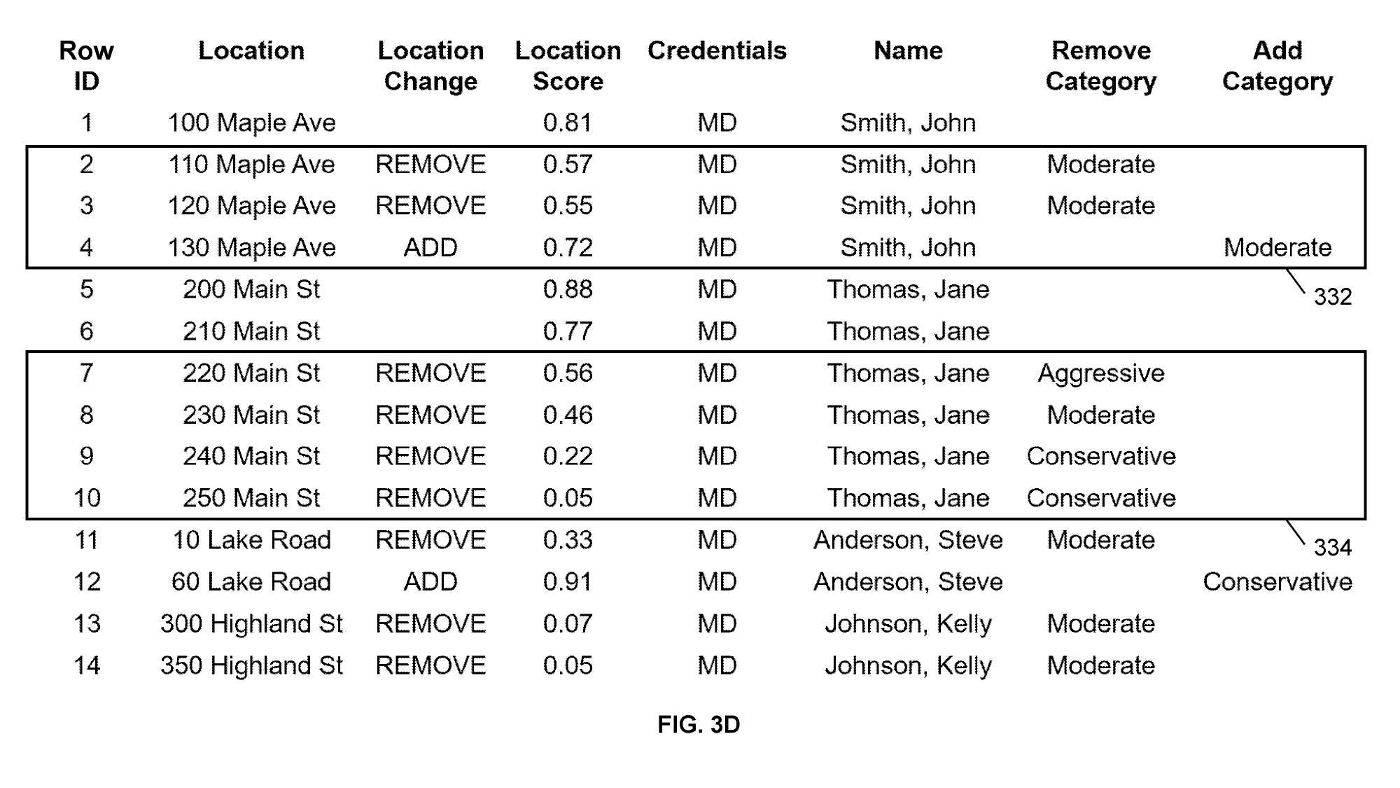

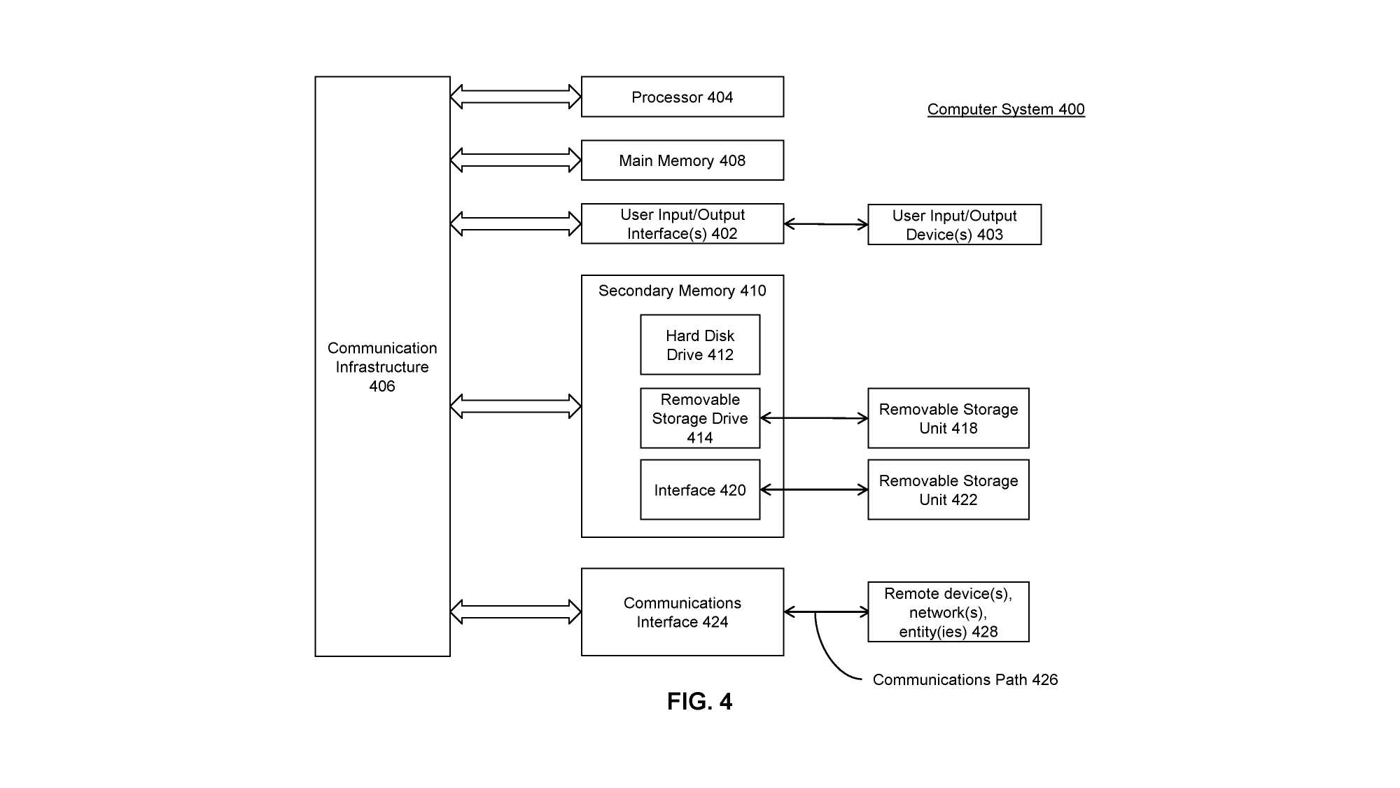

FIG. 2 is a flowchart illustrating a method 200 for managing and recommending changes of demographic information, according to aspects of the present disclosure. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1, FIGS. 3A-3D, and FIG. 4. However, method 200 is not limited to that example aspect.

FIGS. 3A-3D are examples illustrating different actions for managing changes of demographic information, according to aspects of the present disclosure. FIGS. 3A-3D shall be described with reference to FIG. 1, FIG. 2, and FIG. 4.

Referring back to FIG. 2, in 202, a data file containing a plurality of changes associated with one or more fields of one or more entries of demographic information may be received by change management and recommendation system 100, in which a change may have an associated score indicating a confidence level of applying the change. In some aspects, the data file may refer to any data files obtained from a prior change generation engine or system. In some aspects, the plurality of changes may include, but is not limited to, removing the one or more fields of the one or more entries, and/or adding one or more additional fields to the one or more entries. In some aspects, change management and recommendation system 100 may categorize the associated score into at least one of an aggressive action, moderate action, and/or a conservative action. It would be appreciated by a person having ordinary skill in the art that other categories with different score ranges may be used to convert the associated score into different action levels. In some aspects, the categorizing of the associated score into different action levels may be independent between two entries and/or fields. In some aspects, the numeric range of converting a score to an action level may be dynamic and dependent on factors including but not limited to types of a field, attributes of characteristics of an entity, and/or any other factors that may be related to demographic information of an entity at the data file. In some aspects, at some entries, the lower score may result in a more aggressive action level than other entries, and vice versa.

As an illustration, the example of FIG. 3A shows that the data file contains 11 changes at rows 2–4, 7–14 in which the 11 changes are associated with at least a location of the demographic information. A location change may have an associated score that indicates a confidence level of applying the change. For example, regarding Doctor Smith, John, the location change at row 2 has an associated location score as 0.57, indicating that this location change is a moderate action. The 11 location changes, across different Doctors at multiple locations, include but are not limited to a remove category at rows 2–3, 7–11, and 13–14, and an add category at rows 4 and 12.

Furthermore, categorizing a score to an action level may be dynamic and may be determined by factors including but not limited to types of a field, attributes of characteristics of an entity, and/or any other factors that may be related to demographic information of an entity at the data file. In some aspects, cross-fields, cross-entries, cross-tabulation, cross-sectional, and/or any other cross-domains/attributes analysis and/or comparisons may result in a different scoring-to-action categorizing. Specifically, these cross-domain or cross-tabulation analyses may be used to compare the data entries with multiple variables and to identify relationships that might not be obvious from the data file. In some aspects, these analyses can be performed by using a machine learning model and/or any other statistical tools that may input one or more different columns (e.g., fields) and/or rows (e.g., entries) along with the score associated with a specific change of the data file to predict one or more categorical variables for the data file. In some aspects, those analyses could also be performed across the data file at different time stamps to capture any temporal data patterns that may be hidden by only visualizing the data file at one time stamp. By performing the analysis of cross-time-series data file, machine learning models that support time-series analysis may be used, including but not limited to recurrent neural network (RNN), long short-term memory (LSTM) and/or large language model (LLM).

As an illustration in FIG. 3A, in 302, the REMOVE action of location change at row 2 is moderate because the location score as 0.57 may not be a low score. In 304, the ADD action of location change at row 4 is moderate because the new data being added in with a location score as 0.72 is a lower score than the best available already (e.g., row 1 with a location score as 0.81), but the score is still not low enough. In 306, the REMOVE action of location change at row 9 is conservative because the location score as 0.22 is low enough and there already are other good locations available for Doctor Thomas, Jane. Similarly, cross-entries comparisons may be performed among rows 5–10 to result in a REMOVE action of location change at rows 7–10, respectively, because there are already two locations associated with Doctor Thomas, Jane at rows 5–6 with higher location scores. In 308, the ADD action of location change at row 12 is conservative because the location score as 0.91 is a high score and is much better than the exiting location score as 0.33 at row 11 that is being removed. In 310, the REMOVE action of location change at rows 13–14 are moderate because although the scores are low, removing these locations would leave no locations left for Doctor Johnson, Kelly.

Referring back to FIG. 2, in 204, the data file may be aggregated by change management and recommendation system 100 based on identifying the plurality of changes in the one or more fields of demographic information to generate an aggregated data file, in which the aggregated data file, within each of the one or more fields, may remove one or more redundant entries associated with each of the one or more fields that do not have the change.

In some aspects, the data aggregation may be performed by roll-up aggregation techniques that summarize data by ascending a concept hierarchy for one or more dimensions, including but not limited to summarization, averaging, counting, and/or min/max value. In some aspects, the data aggregation may be performed by drill-down aggregation techniques that navigate the data file from a less detailed level to a more detailed one (e.g., explore the data from general to specific), including but not limited to hierarchical drilling and/or dimensional drilling. In some aspects, the data aggregation may be performed by slice and dice aggregation techniques that involve viewing data from different perspectives, including filtering, slicing, and/or dicing. In some aspects, the data aggregation may also be performed by attribute aggregation techniques that involve summarizing the data file based on specific attributes or characteristics (e.g., fields), including but not limited to weighted aggregation and/or grouping and binning by attribute.

As an illustration, the example of FIG. 3A shows the data file before data aggregation. During data aggregation, the location entries at rows 1, and 5–6 may be removed because these entries do not have any changes. These entries are already good locations but they may be updated to associate with a location change if any other entries may be assigned a higher score (e.g., healthcare providers may move to another location). As an illustration, the example of FIG. 3B shows the data file after data aggregation in which only data entries that have associated changes may be retained.

Referring back to FIG. 2, in 206, a user interface may be generated by change management and recommendation system 100 to request a user to provide a user preference, in which the user preference may indicate a field of demographic information in the aggregated data file that the user may want to apply the change and a level of aggressiveness to apply the change. In some aspects, the user preference may include, but is not limited to, a region, a specialty, a cost, and/or an availability of a healthcare provider. It would be appreciated by a person having ordinary skill in the art that other user preferences may be provided by the user in the user interface. In some aspects, the level of aggressiveness to apply the change may include, but is not limited to, a single level of aggressiveness and/or multiple levels of aggressiveness. In some aspects, as the categorizing step in 202, the level of aggressiveness that the user may want to apply the change may include, but is not limited to, an aggressive level, a moderate level, or a conservative level.

In 208, the level of aggressiveness may be compared by change management and recommendation system 100 to respective scores associated with one or more changes within the one or more entries of the aggregated data file to identify a subset of the one or more changes to apply. In some aspects, the comparing between the level of aggressiveness and the respective scores may further include, but is not limited to, categorizing respective scores associated with the change into an action category and/or determining whether the level of aggressiveness matches the action category. The action category may include, but is not limited to, an aggressive, a moderate, and/or a conservative category. In some aspects, change management and recommendation system 100 may categorize the continuous scores associated with the change into the action category using a binning technique in which the binning may divide the range of continuous scores into intervals and assigning the score to a respective bin (e.g., action category). In some aspects, if the level of aggressiveness matches the action category (e.g., they both fell into the same bin or category), change management and recommendation system 100 may identify that the change associated with the score is to be applied. In some aspects, if the level of aggressiveness provided by the user does not match the action category, then there may not be any change actions that can be applied to the data file. In some aspects, even though there may not be a direct match between the level of aggressiveness and any action categories, change management and recommendation system 100 may find the closest action category to perform the change actions, for example, if there are no conservative actions in the data file, any moderate actions may be applied.

In some aspects, change management and recommendation system 100 may use NLP techniques to understand the meaning of different texts describing the level of aggressiveness. In some aspects, change management and recommendation system 100 may also use NLP techniques or machine learning models to analyze and process any multimodal user inputs including but not limited to text, speech, image, and/or video. The multimodal user inputs may be processed to convert them to match specific formatting or types of the action category in the aggregated data file.

As an illustration, the example of FIG. 3B shows that the data file (e.g., after data aggregation but before applying the changes) contains three types of action category including but not limited to aggressive, moderate, and/or conservative categories. For example, in 312, if the level of aggressiveness provided by the user is aggressive, any change actions in the data file with an aggressive remove category may be applied. In 314, if the level of aggressiveness provided by the user is moderate, any change actions in the data file with a moderate category may be applied. For example, change actions with a moderate remove category may be applied at rows 2–3, 8, 11, and 13–14. Change actions with a moderate add category may be applied at row 4. In 316, if the level of aggressiveness provided by the user is conservative, any change actions in the data file with a conservative category may be applied. For example, change actions with a conservative remove category may be applied at rows 9–10. Change actions with a conservative add category may be applied at row 12.

Referring back to FIG. 2, in 210, the subset of the one or more changes to the data file may be applied by change management and recommendation system 100 to generate an updated data file. In 212, the updated data file may be exported to the user by change management and recommendation system 100.

As an illustration, the example of FIG. 3C shows the updated data file when the level of aggressiveness provided by the user is moderate. As such, any change actions in the data file with a moderate category may be applied in which rows 2–3, 8, 11, and 13–14 may be removed, and row 4 may be added. By applying this change, the update data file only has 8 rows remaining (e.g., rows 1, 4–7, 9–10, and 12). This updated data file may then be exported to the user.

Referring back to FIG. 2, in 214, a plurality of scores associated with a plurality of updated changes to be applied may be updated by change management and recommendation system 100 in the updated data file. Due to the dynamic nature of change management and recommendation system 100, the data file may be updated within a period of time. The updating may update the score associated with the change since attributes and/or characteristics of a healthcare provider may be changed within that period of time.

In some aspects, change management and recommendation system 100 may compute a first evaluation metric indicating a data quality of the aggregated data file and a second evaluation metric indicating the data quality of the aggregated data file assuming the identified subset of the one or more changes has been applied, and may then provide, in the user interface, the first evaluation metric and the second evaluation metric to the user to request the user to provide a user input to identify whether the user wants to apply the subset of the one or more changes. In some aspects, the first and/or second evaluation metrics refer to any data quality metrics including but not limited to accuracy, completeness, consistency, timelines, and/or uniqueness. Since data quality may be dynamic, change management and recommendation system 100 may regularly review and update data quality metrics, dimensions, thresholds, and/or tools. Data auditing methods can be used by change management and recommendation system 100 to measure data quality against predefined criteria and standards. In addition, the user may be requested by change management and recommendation system 100 to identify whether they want to apply the changes based on visualizing the difference between the first and the second evaluation metrics. In some aspects, change management and recommendation system 100 may set a threshold to determine if the data qualities differ sufficiently in terms of applying the changes. For example, change management and recommendation system 100 may set a tolerance range to apply the changes if the data qualities vary within an acceptable range. In some aspects, change management and recommendation system 100 may also provide a recommendation to the user, based on quantifying the numeric changes of the data quality, to accept the changes if the data quality improves, or to decline the changes if the data quality reduces.

In some aspects, change management and recommendation system 100 may analyze the data file to generate one or more change recommendations to the user, and may then provide, in the user interface, the generated one or more change recommendations to the user to request the user to provide a user input to identify whether the user wants to apply the one or more change recommendations.

As an illustration, the example of FIG. 3D shows that the one or more change recommendations may be sent to an appropriate user based on the geographical distance. For example, a user at a region may be more interested in enhancing the data quality of demographic information within a radius of that region. In 332, the change actions at rows 2–4 may be sent to a user if the user is located within a distance of 100 Maple Ave. Likewise, in 334, the change actions at rows 7–10 may be sent to a user if the user is located within a distance of 200 Main St. and/or 210 Main St.

In some aspects, change management and recommendation system 100 may use machine learning models to analyze the data file and generate personalized recommendations to the user. In particular, change management and recommendation system 100 may analyze a large amount of data files with demographic information from different healthcare providers in which the patterns, attributes, and/or characteristics of a healthcare provider and any correlations among multiple healthcare providers may be identified by change management and recommendation system 100. Change management and recommendation system 100 may also receive, in user interface, any user preference inputs regarding these healthcare providers including but not limited to user search queries, past medical visits or purchases, and/or user ratings.

In some aspects, change management and recommendation system 100 may then train one or more machine learning models using the large amount of data files with demographic information from different healthcare providers and/or the user preference inputs to those healthcare providers to predict user preferences, recommend healthcare providers to the right users, and/or generate change recommendations to the user regarding change actions to be applied in the data file. For example, the one or more machine learning models may be trained to portray the patterns, attributes, and/or characteristics of a healthcare provider, and/or any correlations among different healthcare providers. The one or more machine learning models may also be trained to provide a connection between the healthcare provider and the users based on the identified patterns, correlations, and/or the user preference.

In some aspects, change management and recommendation system 100 may then, based on the trained machine learning models, predict any user preferences and/or recommend healthcare provider to the user. Change management and recommendation system 100 may, based on the one or more trained machine learning models, also generate change recommendations to the user to enhance the data quality. In particular, change management and recommendation system 100 may, based on the one or more trained machine learning model, identify which demographic information of the healthcare providers may need a change because such information may not follow the patterns, attributes, and/or characteristics of the healthcare provider, and/or any correlations among different healthcare providers. In addition, change management and recommendation system 100 may, based on the one or more machine learning models, then send these change recommendations to the appropriate users who may be familiar with the healthcare providers whose demographic information may need any changes.

In some aspects, to better manage and recommend these dynamic changes and/or their associated scores, the subset of the one or more changes may be stored into a database by change management and recommendation system 100. Change management and recommendation system 100 may then provide, in the user interface, the subset of the one or more changes stored in the database to the user. A user input may be received in the user interface of change management and recommendation system 100 to apply at least one of the subset of the one or more changes in the database to the data file. The stored subset of the one or more changes in the database may then be updated by change management and recommendation system 100 based on the user input. In some aspects, change management and recommendation system 100 may remove the at least one of the subset of the one or more changes in the database that has been applied, and may also add one or more additional changes from the updated data file to the database. In some aspects, change management and recommendation system 100 may update the stored changes in the database periodically over time in which a dynamic database management approach may be used to store, repair, and/or manipulate the changes in an orderly way. In some aspects, change management and recommendation system 100 may also support a user, in the user interface, to make real-time modifications and updates to the stored changes in the database. In addition, change management and recommendation system 100 may have the ability to adapt to changing data requirements or factors including but not limited to scope, size of the system, the organizations management style, and/or the organizations structure, making the database more flexible and efficient in comparison to static databases.

Various aspects may be implemented, for example, using one or more well-known computer systems, such as computer system 400 shown in FIG. 4. For example, aspects herein using the text summarization system may be implemented using combinations or sub-combinations of computer system 400. Also or alternatively, one or more computer systems 400 may be used, for example, to implement any of the aspects discussed herein, as well as combinations and sub-combinations thereof. A “module,” as the term is used herein, is a computational element that performs one or more functions according to computer readable instructions stored on one or more memories or other non-transitory computer-readable media.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400 or processor(s) 404), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 4. In particular, aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method, comprising:
receiving, by one or more computing devices, a data file containing a plurality of changes associated with one or more fields of one or more entries of demographic information, wherein a change has an associated score indicating a confidence level of applying the change;
aggregating, by the one or more computing devices, the data file based on identifying the plurality of changes in the one or more fields of demographic information to generate an aggregated data file, wherein the aggregated data file, within each of the one or more fields, removes one or more redundant entries associated with each of the one or more fields that do not have the change;
generating, by the one or more computing devices, a user interface to request a user to provide a user preference, wherein the user preference indicates a field of demographic information in the aggregated data file that the user wants to apply the change and a level of aggressiveness to apply the change;
comparing, by the one or more computing devices, the level of aggressiveness to respective scores associated with one or more changes within the one or more entries of the aggregated data file to identify a subset of the one or more changes to apply;
applying, by the one or more computing devices, the subset of the one or more changes to the data file to generate an updated data file;
exporting, by the one or more computing devices and in the user interface, the updated data file to the user; and
updating, by the one or more computing devices, a plurality of scores associated with a plurality of updated changes to be applied in the updated data file.

2. The method of claim 1, wherein the plurality of changes comprises:
removing the one or more fields of the one or more entries; and
adding one or more additional fields to the one or more entries.

3. The method of claim 1, further comprising categorizing, by the one or more computing devices, the associated score into at least one of an aggressive action, a moderate action, or a conservative action.

4. The method of claim 1, wherein the user preference comprises a region, a specialty, a cost, and an availability of a healthcare provider.

5. The method of claim 1, wherein the comparing further comprises:
categorizing a respective score associated with the change into an action category; and
determining whether the level of aggressiveness matches the action category.

6. The method of claim 1, further comprising:
computing, by the one or more computing devices, a first evaluation metric indicating a data quality of the aggregated data file;
computing, by the one or more computing devices, a second evaluation metric indicating the data quality of the aggregated data file assuming the identified subset of the one or more changes has been applied; and
providing, by the one or more computing devices and in the user interface, the first evaluation metric and the second evaluation metric to the user to request the user to provide a user input to identify whether the user wants to apply the subset of the one or more changes.

7. The method of claim 1, further comprising:
analyzing, by the one or more computing devices, the data file to generate one or more change recommendations to the user; and
providing, by the one or more computing devices and in the user interface, the one or more change recommendations to the user to request the user to provide a user input to identify whether the user wants to apply the one or more change recommendations.

8. The method of claim 1, further comprising:
storing, by the one or more computing devices, the subset of the one or more changes into a database;
providing, by the one or more computing devices and in the user interface, the subset of the one or more changes stored in the database to the user;
receiving, by the one or more computing devices and in the user interface, a user input to apply at least one of the subset of the one or more changes in the database to the data file; and
updating, by the one or more computing devices, the stored subset of the one or more changes in the database based on the user input.

9. The method of claim 8, wherein the updating the stored subset comprises:
removing the at least one of the subset of the one or more changes in the database that has been applied; and
adding one or more additional changes from the updated data file to the database.

10. A system, comprising:
a memory configured to store operations; and
one or more processors configured to perform the operations, the operations comprising:
receiving a data file containing a plurality of changes associated with one or more fields of one or more entries of demographic information, wherein a change has an associated score indicating a confidence level of applying the change;
aggregating the data file based on identifying the plurality of changes in the one or more fields of demographic information to generate an aggregated data file, wherein the aggregated data file, within each of the one or more fields, removes one or more redundant entries associated with each of the one or more fields that do not have the change;
generating a user interface to request a user to provide a user preference, wherein the user preference indicates a field of demographic information in the aggregated data file that the user wants to apply the change and a level of aggressiveness to apply the change;
comparing the level of aggressiveness to respective scores associated with one or more changes within the one or more entries of the aggregated data file to identify a subset of the one or more changes to apply;
applying the subset of the one or more changes to the data file to generate an updated data file;
exporting, in the user interface, the updated data file to the user; and
updating a plurality of scores associated with a plurality of updated changes to be applied in the updated data file.

11. The system of claim 10, wherein the one or more processors are further configured to perform operations comprising categorizing the associated score into at least one of an aggressive action, a moderate action, or a conservative action.

12. The system of claim 10, wherein the one or more processors are further configured to perform operations comprising:
computing a first evaluation metric indicating a data quality of the aggregated data file;
computing a second evaluation metric indicating the data quality of the aggregated data file assuming the identified subset of the one or more changes has been applied; and
providing, in the user interface, the first evaluation metric and the second evaluation metric to the user to request the user to provide a user input to identify whether the user wants to apply the subset of the one or more changes.

13. The system of claim 10, wherein the one or more processors are further configured to perform operations comprising:
analyzing the data file to generate one or more change recommendations to the user; and
providing, in the user interface, the one or more change recommendations to the user to request the user to provide a user input to identify whether the user wants to apply the one or more change recommendations.

14. The system of claim 10, wherein the one or more processors are further configured to perform operations comprising:
storing the subset of the one or more changes into a database;
providing, in the user interface, the subset of the one or more changes stored in the database to the user;
receiving, in the user interface, a user input to apply at least one of the subset of the one or more changes in the database to the data file; and
updating the stored subset of the one or more changes in the database based on the user input.

15. The system of claim 14, wherein the updating the stored subset comprises:
removing the at least one of the subset of the one or more changes in the database that has been applied; and
adding one or more additional changes from the updated data file to the database.

16. A non-transitory computer-readable storage device having instructions stored thereon, execution of which, by one or more processing devices, causes one or more processors to perform operations comprising:
receiving a data file containing a plurality of changes associated with one or more fields of one or more entries of demographic information, wherein a change has an associated score indicating a confidence level of applying the change;
aggregating the data file based on identifying the plurality of changes in the one or more fields of demographic information to generate an aggregated data file, wherein the aggregated data file, within each of the one or more fields, removes one or more redundant entries associated with each of the one or more fields that do not have the change;
generating a user interface to request a user to provide a user preference, wherein the user preference indicates a field of demographic information in the aggregated data file that the user wants to apply the change and a level of aggressiveness to apply the change;
comparing the level of aggressiveness to respective scores associated with one or more changes within the one or more entries of the aggregated data file to identify a subset of the one or more changes to apply;
applying the subset of the one or more changes to the data file to generate an updated data file;
exporting, in the user interface, the updated data file to the user; and
updating a plurality of scores associated with a plurality of updated changes to be applied in the updated data file.

17. The non-transitory computer-readable storage device according to claim 16, wherein the operations further comprise categorizing the associated score into at least one of an aggressive action, a moderate action, or a conservative action.

18. The non-transitory computer-readable storage device according to claim 16, wherein the operations further comprise:
computing a first evaluation metric indicating a data quality of the aggregated data file;
computing a second evaluation metric indicating the data quality of the aggregated data file assuming the identified subset of the one or more changes has been applied; and
providing, in the user interface, the first evaluation metric and the second evaluation metric to the user to request the user to provide a user input to identify whether the user wants to apply the subset of the one or more changes.

19. The non-transitory computer-readable storage device according to claim 16, wherein the operations further comprise:
analyzing the data file to generate one or more change recommendations to the user; and
providing, in the user interface, the generated one or more change recommendations to the user to request the user to provide a user input to identify whether the user wants to apply the one or more change recommendations.

20. The non-transitory computer-readable storage device according to claim 16, wherein the operations further comprise:
storing the subset of the one or more changes into a database;
providing, in the user interface, the subset of the one or more changes stored in the database to the user;
receiving, in the user interface, a user input to apply at least one of the subset of the one or more changes in the database to the data file; and
updating the stored subset of the one or more changes in the database based on the user input.
